(19) United States
(12) Patent Application Publication
(10) Pub. No.: US 2007/0047888 A1
(43) Pub. Date: Mar. 1, 2007

(54) Capped low loss polymer waveguide and method of making same

(75) Inventor: Fuhan Liu, Altanta, GA (US)

Correspondence Address: Law Offices of Kenneth W. Float, #2F, 2095 Hwy. 211 NW, Braselton, GA, 30517, US

(73) Assignee: Georgia Tech Research Corp.

(21) Appl. No.: 11/507,181

(22) Filed: Aug. 21, 2006

Related U.S. Application Data
(60) Provisional application No. 60/711,703, filed on Aug. 26, 2005.

(51) Int. Cl. G02B 6/10

(52) U.S. Cl. 385/129

(57) ABSTRACT

Disclosed are guided optical devices comprising capped polymer ridged waveguides and methods of fabrication. An exemplary waveguide has a core with a cap (CapClad), bottom cladding and side cladding. The core is patterned together with cap to form the waveguide. The cap protects the core during processing after the core is coated and dried, and the cap layer is coated. Dust particles, contamination, mechanical damage, and process-induced defects on the top surface of the core are eliminated so that waveguide loss is minimized. Propagation loss measurements for reduced-to-practice embodiments have shown a 20% improvement of the capped waveguide over existing waveguides. The manufacturing yield of optical polymer waveguides and waveguide-based polymer devices is expected to be increase.

### STATEMENT REGARDING FEDERALLY SPONSORED RESEARCH OR DEVELOPMENT

This invention was made in part with government support under Contract Number EEC-9402723 awarded by the National Science Foundation. Therefore, the government may have certain rights in this invention.

### BACKGROUND

The present invention relates to waveguides, and more particularly to a capped optical polymer waveguide, and method of making same.

Optical interconnects using polymer waveguides have long been thought to have promise due to its superior high speed to replace the copper transmission lines at a potential low cost. So far, conventional manufacturing processes for polymer waveguides and polymer passive devices do not scale up to allow volume production in the optoelectronics industry. Fabrication of high quality polymer waveguides and passive devices and board-level system integration has been a great challenge.

The widespread use of ball grid array (BGA), chip scale package (CSP), flip chip, and wafer-level-packaging techniques promote development of high density substrates and printed circuit boards (PCBs). However, the speed or bandwidth is limited by copper wires. To realize high speed, integrated high speed optics are required. One of the most important components under development is the optical waveguide. Integrated optical waveguides and waveguide-based polymer passive devices on high density substrates/PCBs are a major program for the optoelectronics industry. In the late 1980s, attempts were made to integrate polymer waveguides into printed circuit boards for interconnection use, without much success.

Numerous technologies have been developed, such as photolithography, reactive ion etching, laser ablation molding/embossing, lamination, and monomers diffusion, for example, to define optical waveguides. Among these technologies, photolithographic technology has an excellent ability to define smooth and high definition waveguides. However, there are process-related challenges that limit manufacturing scaling. Dust particles, contamination, scratches, mechanical damage, chemical swell and corrosion, over-etching or side-etching, for example, will degrade the performance of a high quality waveguide and other polymer devices. A serious defect will break the waveguide or device and results in loss of the whole module or system.

There is a need for high quality waveguides and other guided optical devices having low propagation loss and improved waveguide definition, having fewer process-produced defects and improved manufacturability in a low fabrication cost PCB/package environment.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 is an AFM image showing 4 μm multi-channel waveguides made using PCB facilities with nano-smooth surfaces for single mode applications;

FIGS. 2a and 2b illustrate contamination on top of a waveguide core;

FIGS. 3a-3c illustrate effects of photolithography and the gap between a core layer and a photomask;

FIGS. 4a and 4b illustrate micrograph (dark field) of surface damage to a waveguide;

FIG. 5 conceptually illustrates the structure of a capped polymer waveguide;

FIG. 6 illustrates an exemplary high definition capped polymer waveguide;

FIGS. 7a-7d illustrate process steps for fabricating the exemplary capped polymer waveguide shown in FIG. 6;

FIG. 8 shows an exemplary reduced-to-practice capped polymer waveguide, which was obtained by illuminating an end of the waveguide; no light output escapes through the cap;

FIG. 8a shows a micrograph of an exemplary core formed using a triple-layer process;

FIG. 9 is a flow chart that illustrates an exemplary detailed process flow for fabricating a capped polymer waveguide;

FIG. 10 is a graph that illustrates measured scattered light intensity from an exemplary reduced-to-practice capped polymer waveguide with propagation loss of 0.064 dB/cm;

FIG. 11 is a graph that illustrates measured scattered light intensity from a conventional waveguide with propagation loss of 0.085 dB/cm and also shows a power drop along a defect; and

FIG. 12 is a graph that illustrates the defect effect from an exemplary reduced-to-practice capped polymer waveguide showing no power drop along the defect.

### DETAILED DESCRIPTION

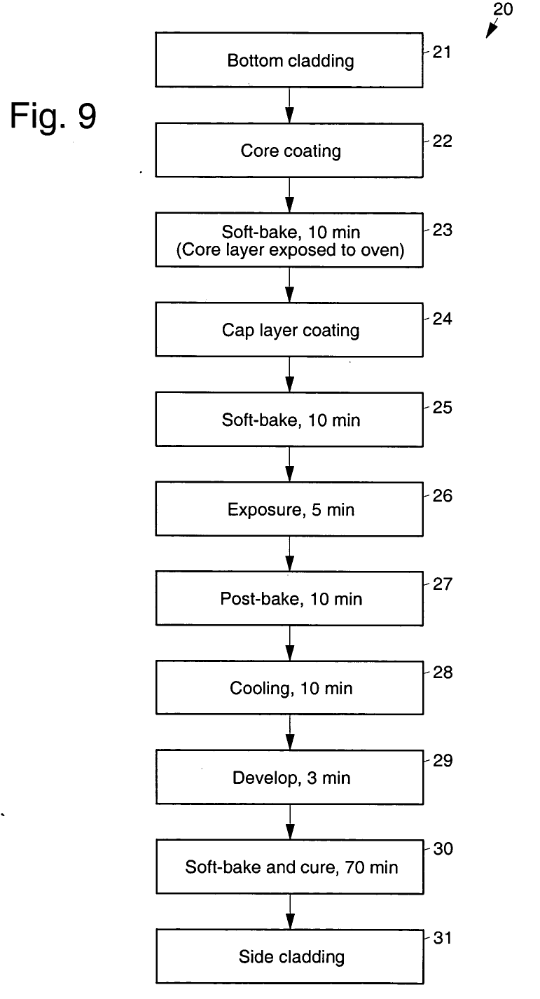

Disclosed is an improved capped polymer optical ridged waveguide 10 (FIGS. 5, 6, 7d, and 8), referred to as a “CapClad” waveguide 10 and methods 20 (FIGS. 5 and 9) of manufacturing the waveguide 10. The waveguide 10 has a core 13, top cladding 14 and bottom cladding 12. The waveguide core 13 is patterned together with top cladding 14 to form a ridge waveguide 10. The top cladding 14 acts as a cap 14. The core 13 of the waveguide 10 is protected by the cap 14 during subsequent processing, after the core 13 is coated and dried. Dust particles, contamination, and mechanical damage, and process-induced defects on the top surface of the core 13 are thus eliminated so that waveguide manufacturing yield is improved and propagation loss is minimized. Propagation loss measurements for reduced-to-practice embodiments have shown a 20% improvement of the capped waveguide 10 over a conventional waveguide. The improvement was proved by observation and comparison of light scattering from defects in the capped waveguide 10 and conventional waveguide. In addition, high definition structure which is most important for those devices that need precise structure such as multimode interference (MMI) devices, for example. Optical splitters may be made by using this approach. The disclosed CapClad waveguide 10 should have a major impact on the manufacturability of integrated optoelectronics in a reasonable clean packaging or PCB environment. No low class clean room is required.

Optical Waveguide Materials

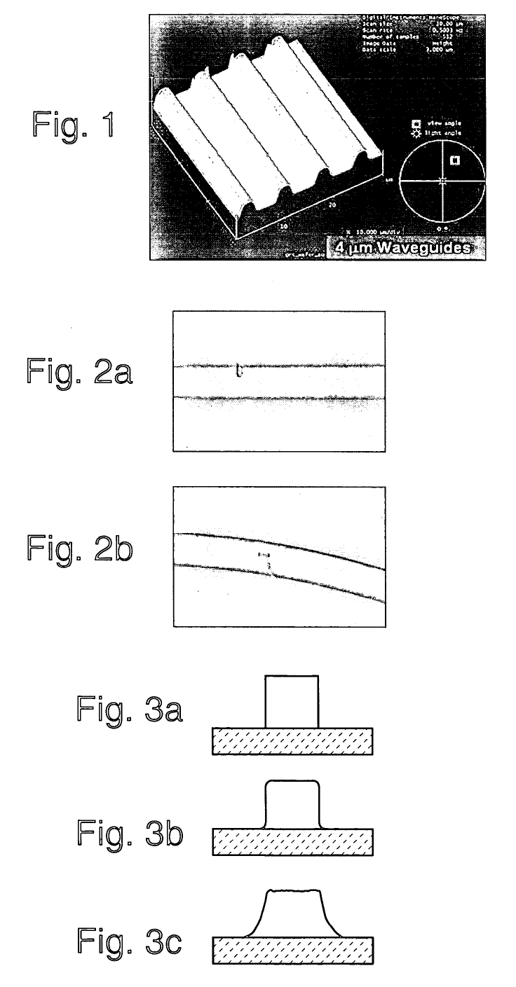

The optical materials preferably used to fabricate the integrated capped waveguide 10 are high transparency polymers. For example, LighLink™ optical polymer manufactured by Rohm & Haas Electronic Materials may be used. The LightLink optical polymer is a polysiloxane-based polymer having two parts with higher and lower refractive indices refractive index. The higher refractive index material is used for the core 13 and the lower refractive index material is used for the cladding 12, 14. The materials are in monomer liquid form, and they are applied either by spin coating, slot coating or meniscus coating on a substrate which may be silicon, glass, ceramic, organic package substrate or a printed circuit board. Both the core 13 and cladding 12, 14 are photo-imageable with high resolution. The photolithography process allows definition of structures of having dimensions from a few microns to a few hundred microns with a high degree of accuracy, so that high performance single mode and multimode waveguide 10 and polymer related passive devices may be made for use in integrated optoelectronics. FIG. 1 shows a 4-micron waveguide 10 on an 8-micron pitch multi-channel waveguide 10 with smooth surface and walls taken using atomic force microscopy (AFM). These high density polymeric channel waveguides 10 were made by using low cost printed circuit boards (PCBs) facilities and process in a class-1000 substrate laboratory at the NSF-Packaging Research Center.

Waveguide Propagation Losses

Unlike conventional optical glass fiber, an optical polymer waveguide has a much higher propagation loss. For example, the loss of optical fiber is about 0.1 dB/km, while the loss of a typical unfluorinated polymer waveguide is 0.20˜3 dB/cm at 1310 nm and 0.5˜1.5 dB/cm at 1550 nm. The loss can be 0.1˜0.02 dB/cm at 850 nm, but it is quite sensitive to its fabrication process. Processing or fabrication of low loss waveguides becomes a key for the success of using polymer waveguides in practical applications. The transmission loss of a waveguide can be categorized as intrinsic and extrinsic. The intrinsic loss is from material absorption and compositional inhomogeneities while the extrinsic propagation loss is mostly generated by the processing. Scattering from defects such as contamination, bubbles, dimples, bumps, cracks, surface roughness, and poor definition produces most of the waveguide loss. The optical waveguide needs to have clear and smooth surfaces. An ultra-clear environment is required for large area board level optoelectronics integration which results in increased costs. Disclosed herein are techniques that eliminate process-produced defects and reduce environmental requirements by using the capped waveguide 10.

Manufacture Challenges and Environment Requirements

FIG. 5 shows a typical optical polymer waveguide 10 having a triple-layer structure: bottom cladding 12, core 13, and top cladding 14. Using conventional waveguide fabrication, these three layers are formed layer-by-layer from bottom cladding 12 to top cladding 14 (and side cladding 15 is included) in a sequence process. The process includes coating, soft-baking, and curing. In addition, the core 13 is patterned after soft-baking. For board level integration, soft-baking usually takes around 10 minutes at low temperature, while curing takes 1 hour to a few hours at high temperature. In the formation of the core 13, a contact mode UV exposure is used followed by post-bake and development in a chemical solution, and then the core 13 cured in a convection oven for about 1 hour. During the long processing period, the top surface of the core 13 experiences the effects of mechanical contact, chemical solutions, the convention oven, and a lot of handling. Defects and damage such as contamination, dust, scratches and dimples, and bubbles, and the like, often happen during these multiple manufacturing processes. The surface of the waveguide core becomes rough as well. Polymers are extremely sensitive to dust particles because of their high insulation properties because static charges are easily built-up. As a result, dust particles are more readily attracted to a fresh surface, even in an ultra clean-room environment. Scattering can be considerably large if the size of defects is comparable to the propagation wavelength or larger, say 1 micron or larger.

FIGS. 2a and 2b are micrographs that illustrate the most practical achievable structure using contact lithography and the substrate-photomask gap effect on the image transferring from the photomask to the substrate. FIG. 2a shows a particle with a 10 μm diameter that has come in contact with the top of a well-defined waveguide during the curing process in a convection oven. FIG. 2b shows debris of the polymer residue with a size of 5 μm×30 μm stuck on a waveguide core generated during development (wet etching). Once these particles adhere to the waveguide, they cannot be removed. To increase the manufacturing yield and low loss waveguide processing, ultra-clean rooms, special storage and handling technologies and careful precautions are required. Thus, fabrication cost will be very high. However, disclosed herein is a simple way to considerably reduce the effects of fabrication defects and improve the manufacturability, in a low cost package/PCB environment.

For high performance waveguide and passive devices, correct structure size must be achieved. In order to minimize the light diffraction effect, the substrate/board 11 must come into contact with the photomask for best resolution and best definition. The resolution as a function of separation can be expressed by the equation 2bₘᵢₙ=3\sqrt{λG}, where bₘᵢₙ is the finest line spacing that can be achieved, λ is the UV wavelength of a lamp that is used, and G is the gap between the polymer film and the photomask. From this equation, it can be seen that increased separation results in a large degradation in resolution. Besides degrading the resolution, definition of the device structure is degraded. FIGS. 3a to 3c show the substrate-photomask gap effect on an image transferring from the photomask to the substrate. FIG. 3a shows a perfectly designed square structure. This square structure becomes a rather complex shape that depends on the gap size. In most cases, the fabricated structure will have round corners on the top and sometimes small feet on the bottom, as shown in FIG. 3b. Further, the structure may have a rather complex shape depending on the distance of the gap between the core layer and the photomask. FIG. 3c shows a possible shape of the waveguide obtained using proximity lithography.

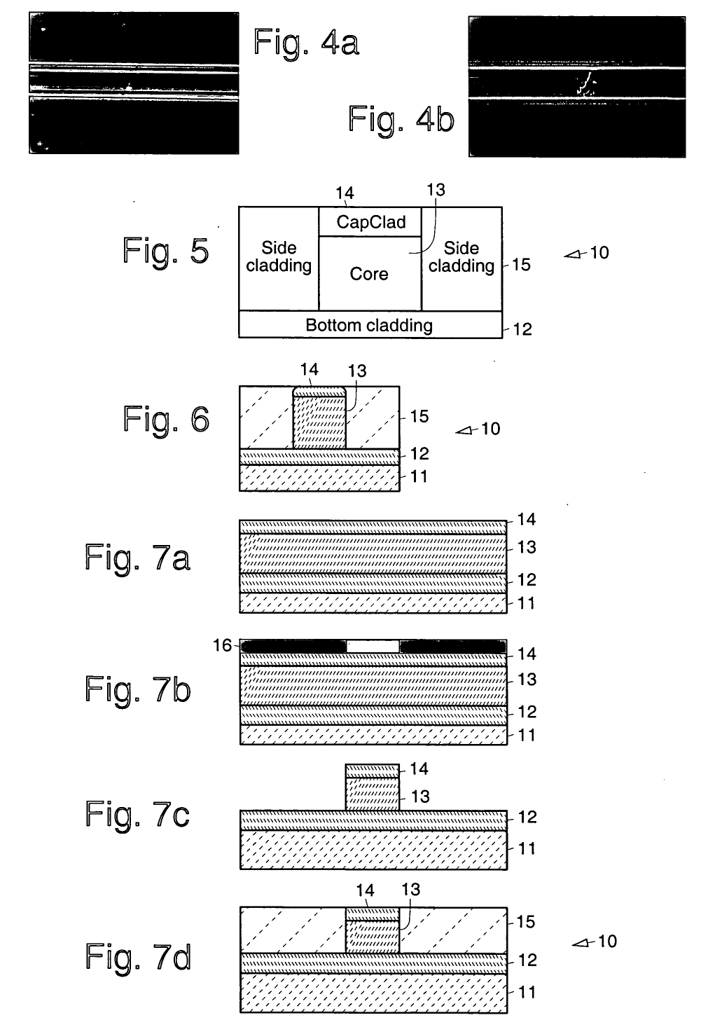

Contact mode is commonly used for high definition waveguide formation. However, contact between the core 13 and the photomask is a potential cause of mechanical damage. FIG. 4a shows a scratch on a waveguide that occurred during fabrication and FIG. 4b shows damage that occurred due to photomask contact. Dark field photography was used to clearly show the defects in FIGS. 4a and 4b. All the defects described above cause a decrease in manufacturing yield and increased scattering loss as well. Therefore, defect-free or defect-less, nano-smooth surfaces, and high definition are required for fabricating low loss waveguides and other passive devices. The techniques disclosed herein that produce the capped waveguide 10 prevent the core 13 from contacting the photomask so that damage caused by contact is avoided.

Capped Waveguide Fabrication and Integration

FIG. 5 conceptually illustrates the structure of a capped polymer waveguide 10. The capped polymer waveguide 10 comprises a bottom cladding layer 12 and a top cladding layer (cap) 14 and side cladding 15 that sandwich or enclose a central core 13. FIG. 6 illustrates an exemplary capped polymer waveguide 10 with high definition in concept. The bottom cladding layer 12 is disposed on a substrate 11. The central core 13 and top cladding layer 14 have a reduced dimension relative to the bottom cladding layer 12 and the substrate 11. The rounded top corners occur on the cap 14 due to over-etching, while the core 13 has a well-defined shape.

FIGS. 7a-7d generally illustrate process steps for fabricating the exemplary capped polymer waveguide 10 shown in FIG. 6. As is shown in FIG. 7a, the bottom cladding layer 12 is deposited on a substrate 11 and dried, the core 13 is deposited on the bottom cladding layer 12 and dried, and the top cladding layer 14 is deposited on top of the core 13 and dried. As is shown in FIG. 7b, the structure of the waveguide 10 is defined using photolithography, using a wet or dry process, wherein a photolithographic mask 16 (photomask 16) is disposed on top of the top cladding layer 14. As is shown in FIG. 7c, the top cladding layer 14, core 13 and bottom cladding layer 12 are etched to form the desired structure of the waveguide 10. The top cladding layer 14 acts as both cap and cladding in the capped waveguide structure. Finally, side cladding material 15 is coated on the formed structure, as is shown in FIG. 7d. It is clear that the cap cladding layer 14 protects the core 13 since it is coated on the core layer 13 prior to any subsequent processing. The core layer 13 is only exposed to over-drying for about 10 minutes. In contrast, the core layer of conventional waveguides is exposed to multiple process and handling steps including direct contact with the photomask for over 2 hours.

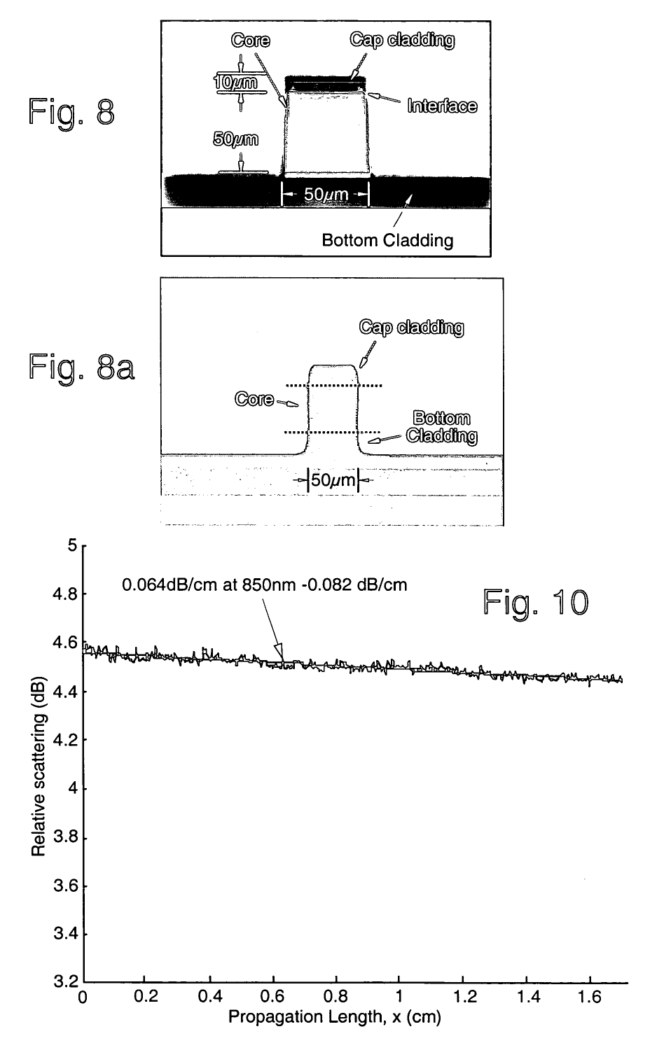

FIG. 8 shows an exemplary reduced-to-practice capped polymer waveguide core 10 (before side cladding 15 is coated) fabricated using the process flow discussed with reference to FIGS. 7a-7d. FIG. 8 shows typical dimensions for the exemplary reduced-to-practice capped polymer waveguide core 10 for multi-mode applications. The picture was taken by illuminating the end of the waveguide 10 with white light. The waveguide core 13 is bright because of the guided light. No light was seen escaping from the cap cladding 14 so the cap 14 is dark.

Because of the excellent capability to define the structure having smooth surface, high resolution and high accuracy, a photolithographic technology is preferably used to fabricate the capped waveguide 10. In the capped waveguide 10, the cap cladding layer 14 (top cladding 14) is added to a soft-baked core layer 13 (core 13) and then they are defined together. FIG. 9 is a flow chart that illustrates an exemplary more detailed process flow 20 or method 20 for fabricating the capped waveguide 10. The detailed process flow 20 is as follows.

First, coat 21 the bottom cladding layer on a substrate or printed circuit board (PCB) and cure it. Next, coat 22 the core layer 13 and soft-bake 23 it. Next, coat 24 the cap cladding layer 14 on the core layer 13 and soft-bake 25 it. The core 13 and top cladding layers 14 are subsequently exposed 26 an appropriate dose of UV radiation through a photomask 16. The structure may be post baked 27 and cooled 28, as required. Then, a wet process, for example, may be used to develop 29 the pattern. The developer used for patterning LightLink waveguide material, for example, is an aqueous solution (2% Alkaline). Development may be carried out at room temperature for about 3 minutes. Unexposed areas are dissolved and washed away and exposed areas remain. The cladding layer 14 on the top of the core 13 acts as both cladding and cap 14, and is referred to as CapClad. In this structure the surface of the core 13 is protected by the cap 14 during subsequent processing. The structure is then soft-baked 31 and cured. The capped waveguide 10 is completed by applying 32 a layer of polymer to clad sides of the core 13.

Defects in the interface of the core 13 and cap 14 caused by processing discussed above are substantially eliminated. Defects do not entirely disappear but are transferred from the top of the core layer 13 to the top of the cap cladding layer 14 which has less effect on light propagation in the core layer 13. It is quite clear that the surface contact problem is solved and the defect problem is substantially eliminated in fabricating the capped waveguide 10. Contamination and damage of the top surface of the core 13 is greatly reduced in the capped waveguide 10 compared to conventional waveguides. Sidewalls of the core layer 13 experience the same processing for both conventional waveguide and the capped waveguide 10. However, the probability that defects will happen on side surfaces of the core layer 13 is much lower than that of the top surface. Since there is no contact with the sidewalls of the core layer 13 during processing, no contact damage occurs. In addition, the possibility of dust particles falling on the sidewalls is much smaller that falling on the top of the core layer 13, and the time that the sidewalls are exposed to air is shorter. The sidewalls are exposed only after the core 13 is patterned.

High Definition Waveguide and Passive Devices

In general, the structure of waveguides and polymeric passive devices, such as a Y-splitters, H-trees, MMI devices, and switches, etc., are designed with square or rectangular shapes. However it has heretofore been difficult to achieve devices with a highly precise structure using practical processes. Round shapes on the top of devices as shown in FIG. 6 usually happen due to over-etching of the sharp edge using a wet etch process. It is well-known that a sharp edge is easily attacked and becomes round and looses definition. The problem can be solved if the core 13 has the cap 14 clad on top of it that protects the core 13 during patterning. In the middle of FIG. 6, for example, it can be seen how a high definition structure can be achieved. The cap 14 becomes round but the core 13 is well defined. FIG. 8 shows an image of a well-defined polymer waveguide core 13 with the cap 14 clad on the top. The dimensions of the core 13 are 50×50 μm² and the thickness of the cap 14 is 10 μm. The core 13 has excellent definition with a square shape.

The process described above is based on core 13 and CapClad 14 formation together and may be referred to as dual-layer CapClad waveguide 10. A three-layer formation process may be employed to form the CapClad waveguide 10 as well which may be referred to as a triple-layer process. The difference between the triple-layer process and the dual-layer process relates to the bottom cladding 12. In a triple-layer process, the bottom cladding layer 12 only needs soft baking while in dual-layer process the bottom cladding layer 12 is cured. Since all the three layers 12, 13, 14 only experience a soft bake, they are patterned simultaneously during the lithographic process. The advantages of triple-layer formation is that the foot effect on the bottom cladding layer 12 can be avoided which results in good definition. FIG. 8a shows a micrograph of an exemplary core 13 formed using a triple-layer process. It can be seen that the structure is rounded on the top corners and on the bottom feet. The middle part is waveguide core 13 has excellent definition.

Capped Waveguide Characterization and Comparison

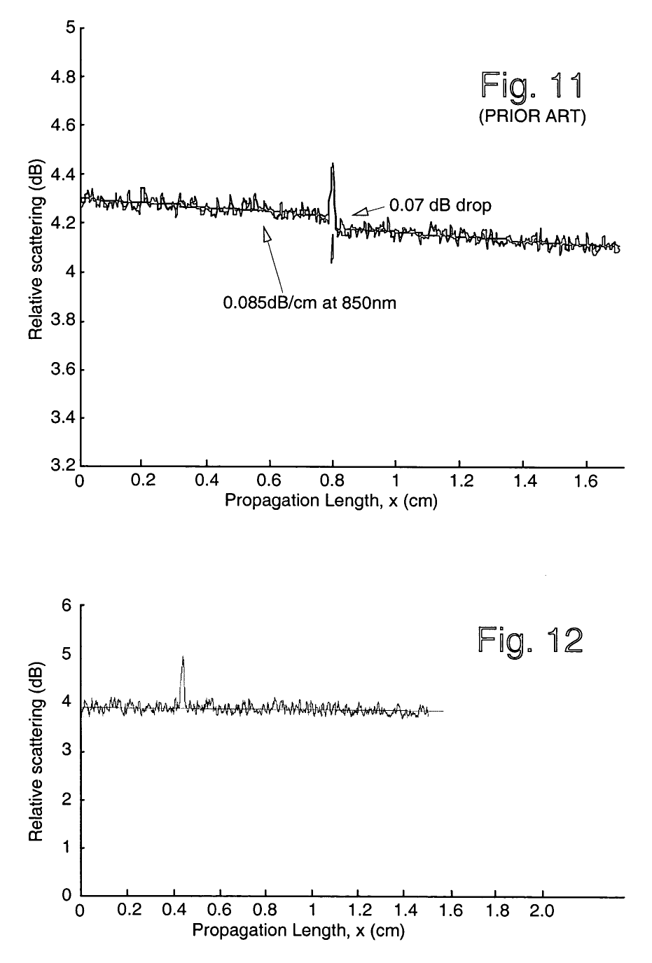

A computer-assisted CCD camera with built-in integration function was developed to evaluate the performance of the capped waveguide 10. The integrated CCD camera has a wide dynamic range and provides a fast, high precision, sensitive, and non-destructive capability to evaluate loss measurement and behavior for low loss high performance waveguide. Scattered light from the waveguide 10 is detected by the CCD camera. The intensity of the scattered light is a function of the intensity of the light propagating inside the waveguide 10. A profile of the power distribution along the waveguide 10 can be measured. The light propagation loss can be deduced from the measured intensity profile. FIG. 10 shows a graph illustrating collected data, data fitting and results for a capped waveguide 10. The wavelength of light beam used for the characterization was 850 nm. It can be seen that the relative scattering intensity (dB) has a linear relationship with propagation distance. Least mean squares is employed for curve fitting. The propagation loss of the capped waveguide 10 can be deduced from the slope of the straight line, which is 0.064 dB/cm. For comparison, conventional waveguides were made, i.e., cores of the waveguides were formed and cured and then the top cladding layer was added. No cap was added to protect the core during the core formation. The same materials and same processes conditions were used for both capped waveguide 10 and conventional waveguide fabrication. FIG. 11 shows a graph illustrating collected data, data fitting and results for a conventional waveguide. A peak may be observed on the curve for the conventional waveguide in FIG. 11. The peak made the fitting straight line discontinuous. There is a 0.07 dB power drop before and after the peak. This peak was caused by strong light scattering due to a defect generated during processing. The curve fitting cannot be made on the whole scale due to the discontinuity. The propagation loss curve fitting was done before the peak and after the peak. The propagation loss was 0.085 dB/cm for the conventional waveguide obtained by averaging of the two fitted curves.

It is seen that the capped waveguide 10 has about a 20% improvement in propagation loss over the conventional waveguide. For further understanding the effect of the cap 14 in the CapClad waveguide 10, a capped waveguide 10 with a defect was measured. FIG. 12 shows a graph illustrating collected data and data fitting for a capped waveguide 10 with a defect. In FIG. 12, a peak is observed due to light scattering from the defect. However, no power drop is seen. The fitting line is a continuous straight line. The experimental comparison of the capped waveguide 10 (average of measurements on two samples) and the conventional waveguide (average of measurements on two samples) is listed in Table 1.

TABLE 1
Comparison of waveguide propagation losses

| | Type of waveguide | |
|---|---|---|
| | Conventional waveguide | Capped waveguide |
| Propagation loss, dB/cm | 0.085 | 0.065 |
| Defect Loss, dB | 0.07 | Not observed |

Because there is an intensity drop across the defect in the conventional waveguide and there is no intensity drop across the defect in the capped waveguide 10, it can be deduced that the defect causes a power loss in the conventional waveguide, while the defect does not cause an obvious power loss in the capped waveguide 10. It is assumed that the defect in the conventional waveguide that produced the power loss is located at the interface of the core and top cladding layer. The defect in the capped waveguide 10 is most likely located on top of the cap 14 which is far away from the core 13, thus eliminating the power effect caused by the defect. Most defects in the capped waveguide 10 were shifted from the core 13 to the top of the cap 14, which has less effect on light propagating in the core layer 13 that results in lower propagation loss.

The test results are summarized as follows: (1) defects on the core 13 cause serious power loss, (2) defects on the cap 14 have little or no effect on power loss, (3) defects can be shifted or transferred away from core 13 by adding the CapClad (cap) layer 14, (4) waveguide propagation loss can be reduced and manufacturability may be improved with the capped waveguide 10, (5) high quality optical waveguides that are defect insensitive may be manufactured in PCB/package environment and no low class clean room is required, which greatly reduces fabrication processing costs, and (6) not only is loss reduced, but more importantly, fabrication yield is increased which will have a big impact on volume production for the optoelectronics industry.

While the above fabrication processing has addressed the use of wet etching processes, it is to be understood that the capped waveguide 10 may be fabricated using wet etching processes, dry etching processes (reactive ion etching), laser ablation processes, molding processes, embossing or stamping processes, for example. Because the cap layer 14 protects the core layer 13, any of these processing methodologies may be employed to fabricate defect-free, high optical quality guided optical devices.

Thus, a capped waveguide 10 (CapClad waveguide 10) having improved manufacturability for integrated optoelectronics was developed and fabricated. Measurements and comparison of capped waveguides 10 to conventional waveguide show that the capped waveguide 10 has the advantages of (1) eliminating waveguide defects to provide improved propagation loss, (2) improving the definition of waveguide structures allowing fabrication of high performance waveguide devices, (3) improving structure variability to provide increased productivity, (4) reducing the requirement for an ultra-clean environment so that optics can be integrated in system packages in a cost-effective package/PCB environment, and (5) increasing the manufacturing yield. The capped waveguide 10 should thus have a large impact on manufacturability and for optoelectronics integration in system packages.

Thus, low loss capped polymer waveguides and fabrication methods have been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. Optical waveguide apparatus comprising:
a bottom cladding layer;
a core layer formed on the bottom cladding layer; and
a cap layer formed on the top of core layer that protects the waveguide core.

2. The apparatus recited in claim 1 further comprising side cladding formed on sides of the core layer.

3. The apparatus recited in claim 2 wherein:
the core layer is made of a polymer material having a first refractive index;
the cap layer is made of a polymer material having a second refractive index that is lower that the first refractive index; and
the side cladding is made of the polymer material the second refractive index.

4. The apparatus recited in claim 1 wherein the bottom cladding layer is formed on an underlying substrate.

5. The apparatus recited in claim 4 wherein the substrate is selected from a group including silicon, glass, ceramic, organic package substrate or a printed circuit board.

6. The apparatus recited in claim 1 wherein the cap layer, the core layer and the bottom cladding layer are made of polymer material.

7. The apparatus recited in claim 1 wherein dimensions of the cap layer and the core layer are photolithographically defined.

8. The apparatus recited in claim 1 wherein the cap layer and the core layer are patterned together, and are patterned using a dry etching process, a laser ablation process, a molding process, an embossing process, or a stamping process.

9. A method of fabricating optical waveguide apparatus, comprising
forming a bottom cladding layer on a substrate;
forming a core layer on the dried bottom cladding layer;
forming a top cap layer on the core layer;
disposing a mask layer above the top cap layer that defines a waveguide structure; and
processing the top cap layer and core layer using the mask to define an optical waveguide, leaving the cap in place.

10. The method recited in claim 9 further comprising:
forming a protective cladding layer on side surfaces of the core layer.

11. The method recited in claim 9 further comprising:
forming side cladding layer on exposed surfaces of the cap layer, the core layer, and the bottom cladding layer.

12. The method recited in claim 9 wherein etching is performed using a wet etching process.

13. The method recited in claim 9 wherein etching is performed using a dry etching process.

14. The method recited in claim 9 wherein the cap layer, the core layer, and the bottom cladding layer are made of polymer material.

15. The method recited in claim 9 wherein the cap layer, the core layer, and the bottom cladding layer are formed by spin coating, slot coating or meniscus coating.

16. A method of fabricating optical waveguide apparatus, comprising
depositing a bottom cladding layer on a substrate;
drying the bottom cladding layer and substrate;
depositing a core layer on the dried bottom cladding layer;
drying the core layer;
depositing a top cap layer on the core layer;
drying the top cap layer;
placing a mask layer above the top cap layer that defines a waveguide structure; and
etching and developing the top cap layer and core layer using the mask to define an optical waveguide, leaving the cap in place.

17. The method recited in claim 16 further comprising:
depositing a side cladding layer on side surfaces of the core layer.

18. The method recited in claim 16 further comprising:
depositing a side cladding layer on exposed surfaces of the cap layer, the core layer, and the bottom cladding layer.

19. The method recited in claim 16 wherein the cap layer, the core layer, and the bottom cladding layer are made of polymer material.

20. The method recited in claim 16 wherein the cap layer, the core layer, and the bottom cladding layer are deposited by spin coating, slot coating or meniscus coating.
